(19) United States
(12) Patent Application Publication
(10) Pub. No.: US 2018/0127301 A1
(43) Pub. Date: May 10, 2018

(54) GLASS MATERIAL PRODUCTION METHOD

(71) Applicants: NIPPON ELECTRIC GLASS CO., LTD., Otsu-shi, Shiga (JP); The University of Tokyo, Bunkyo-ku, Tokyo (JP)

(72) Inventors: Fumio SATO, Otsu-shi (JP); Tomoko YAMADA, Otsu-shi (JP); Hiroyuki INOUE, Bunkyo-ku (JP); Atsunobu MASUNO, Bunkyo-ku (JP)

(21) Appl. No.: 15/565,471

(22) PCT Filed: Jun. 10, 2015
(86) PCT No.: PCT/JP2015/066711

§ 371 Date: Oct. 10, 2017

(51) Int. Cl. C03B 40/04; C03B 5/235; C03B 19/10

(52) U.S. Cl. CPC C03B 40/04; C03B 19/1005; C03B 5/235

(57) ABSTRACT

The development of cracks or breakage in a glass material during production of the glass material by a containerless levitation technique is reduced. A glass material is obtained by heating a levitated block 12 of glass raw material to melting by irradiation of the block 12 of glass raw material with laser light to thus obtain a molten glass and then cooling the molten glass. A first irradiation step and a second irradiation step are performed. In the first irradiation step, the levitated block 12 of glass raw material is heated to melting by irradiating the block 12 of glass raw material with the laser light. In the second irradiation step, an intensity of the laser light being applied to the molten glass is reduced and irradiation with the laser light is then stopped.

### TECHNICAL FIELD

The present invention relates to glass material production methods.

### BACKGROUND ART

In recent years, studies on containerless levitation techniques as glass material production methods are being conducted. For example, Patent Literature 1 describes a method for vitrifying a barium-titanium-based ferroelectric sample by heating the barium-titanium-based ferroelectric sample levitated in an aerodynamic levitation furnace to melting by irradiation with a laser beam and then cooling it. As just described, the containerless levitation techniques can reduce the progress of crystallization of a material due to contact with the wall surface of a container and, therefore, can vitrify even materials that could not be vitrified by conventional production methods using containers. Hence, the containerless levitation techniques are noteworthy as methods that can produce glass materials having novel compositions.

### CITATION LIST

### Patent Literature

Patent Literature 1: JP-A-2006-248801

### SUMMARY OF INVENTION

### Technical Problem

When, for example, a large glass material is produced by a containerless levitation technique, the glass material may develop cracks or breakage.

A principal object of the present invention is to reduce the development of cracks or breakage in a glass material during production of the glass material by a containerless levitation technique.

### Solution to Problem

A glass material production method according to the present invention is a glass material production method for obtaining a glass material by heating a levitated block of glass raw material to melting by irradiation of the block of glass raw material with laser light to thus obtain a molten glass and then cooling the molten glass. The glass material production method according to the present invention includes a first irradiation step and a second irradiation step. In the first irradiation step, the levitated block of glass raw material is heated to melting by irradiating the block of glass raw material with the laser light. In the second irradiation step, an intensity of the laser light being applied to the molten glass is reduced and the irradiation with the laser light is then stopped.

In the glass material production method according to the present invention, the intensity of the laser light is preferably gradually reduced in the second irradiation step.

In the glass material production method according to the present invention, a ratio of the intensity P₂ of the laser light just before the irradiation with the laser light is stopped to the intensity P₁ of the laser light applied during heating to melting of the block of glass raw material (P₂/P₁) is preferably 0.95 or less.

In the glass material production method according to the present invention, it is preferred that the block of glass raw material be irradiated with the laser light in a state where the block of glass raw material is held levitated above a forming surface of a forming die by jetting gas through a gas jet hole opening on the forming surface, and the gas be preheated and supplied into the gas jet hole.

### Advantageous Effects of Invention

The present invention can reduce the development of cracks or breakage in a glass material during production of the glass material by a containerless levitation technique.

### BRIEF DESCRIPTION OF DRAWINGS

FIG. 1 is a schematic cross-sectional view of a glass material production device according to a first embodiment.

FIG. 2 is a diagrammatic plan view of a portion of a forming surface in the first embodiment.

FIG. 3 is a timing chart representing the intensity of laser light in the first embodiment.

FIG. 4 is a timing chart representing the intensity of laser light in a modification of the first embodiment.

FIG. 5 is a schematic cross-sectional view of a glass material production device according to a second embodiment.

### DESCRIPTION OF EMBODIMENTS

Hereinafter, a description will be given of examples of preferred embodiments for working of the present invention. However, the following embodiments are merely illustrative. The present invention is not at all limited to the following embodiments.

Throughout the drawings to which the embodiments and the like refer, elements having substantially the same functions will be referred to by the same reference signs. The drawings to which the embodiments and the like refer are schematically illustrated. The dimensional ratios and the like of objects illustrated in the drawings may be different from those of the actual objects. Different drawings may have different dimensional ratios and the like of the objects. Dimensional ratios and the like of specific objects should be determined in consideration of the following descriptions.

### First Embodiment

In this embodiment, a description will be given of a method in which not only normal glass materials but also glass materials having compositions that could not be vitrified by melting methods using containers, such as for example compositions free from network forming oxides, can be suitably produced. According to the method of this embodiment, specifically, for example, barium titanate-based glass materials, lanthanum-niobium composite oxide-based glass materials, lanthanum-niobium-aluminum composite oxide-based glass materials, lanthanum-niobium-tantalum composite oxide-based glass materials, lanthanum-tungsten composite oxide-based glass materials, and so on can be suitably produced.

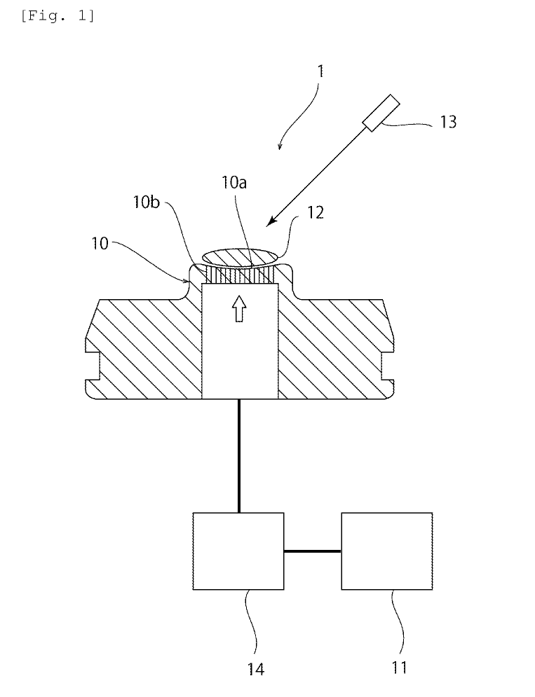

FIG. 1 is a schematic cross-sectional view of a glass material production device 1 according to a first embodiment. As shown in FIG. 1, the glass material production device 1 includes a forming die 10. The forming die 10 has a forming surface 10a. The forming surface 10a is a curved surface. Specifically, the forming surface 10a is spherical.

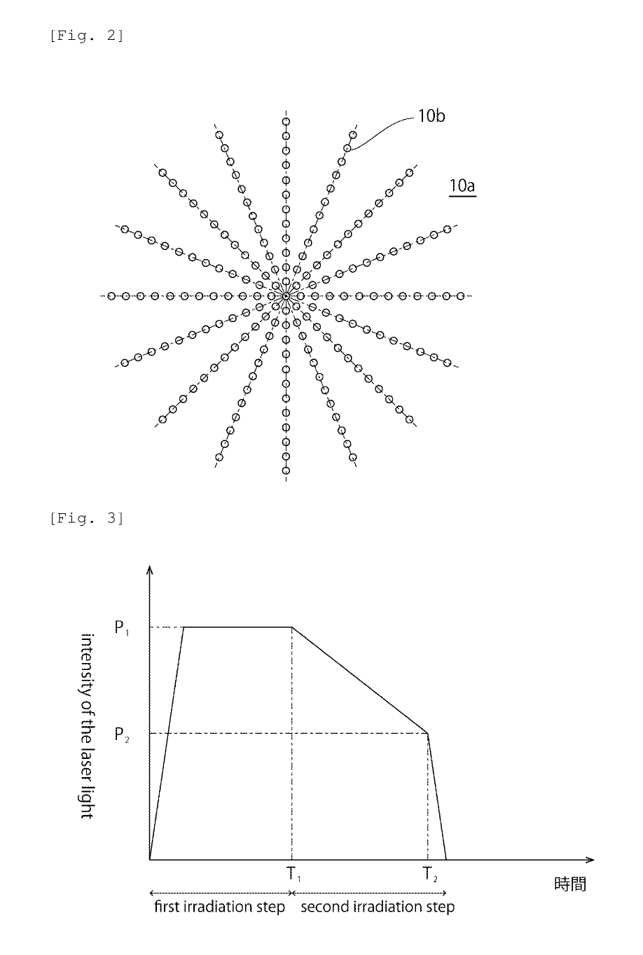

The forming die 10 has gas jet holes 10b opening on the forming surface 10a. As shown in FIG. 2, in this embodiment, a plurality of gas jet holes 10b are provided. Specifically, the plurality of gas jet holes 10b are arranged radially from the center of the forming surface 10a.

The forming die 10 may be made of a porous body having interconnected cells. In this case, the gas jet holes 10b are each formed of interconnected cells.

The gas jet holes 10b are connected to a gas supply mechanism 11, such as a compressed gas cylinder. Gas is supplied from this gas supply mechanism 11 via the gas jet holes 10b to the forming surface 10a.

No particular limitation is placed on the type of the gas. The gas may be, for example, air or oxygen or may be inert gas, such as nitrogen, argon or helium gas.

In producing a glass material using the production device 1, first, a block 12 of glass raw material is placed on the forming surface 10a. The block 12 of glass raw material may be, for example, one obtained by forming raw material powders for a glass material in a single piece by press forming or so on. The block 12 of glass raw material may be, for example, a sintered body obtained by forming raw material powders for a glass material in a single piece by press forming or so on and then sintering the single piece. Alternatively, the block 12 of glass raw material may be, for example, an aggregate of crystals having the same composition as a desired glass composition.

No particular limitation is placed on the shape of the block 12 of glass raw material. The block 12 of glass raw material may have, for example, a lens-like, spherical, cylindrical, polygonal, cuboidal, or oval-spherical shape.

Next, gas is jetted out through the gas jet holes 10b, thus levitating the block 12 of glass raw material above the forming surface 10a. In other words, the block 12 of glass raw material is held out of contact with the forming surface 10a. In this state, the block 12 of glass raw material is irradiated with laser light from a laser light applicator 13. Thus, the block 12 of glass raw material is heated to melting to make it vitrifiable, thereby obtaining a molten glass. Thereafter, the molten glass is cooled, so that a glass material can be obtained. During the process of heating the block 12 of glass raw material to melting and the process of cooling the molten glass and in turn the glass material at least to below the softening point, at least the jetting of gas is preferably continued to reduce the contact of the block 12 of glass raw material, the molten glass or the glass material with the forming surface 10a.

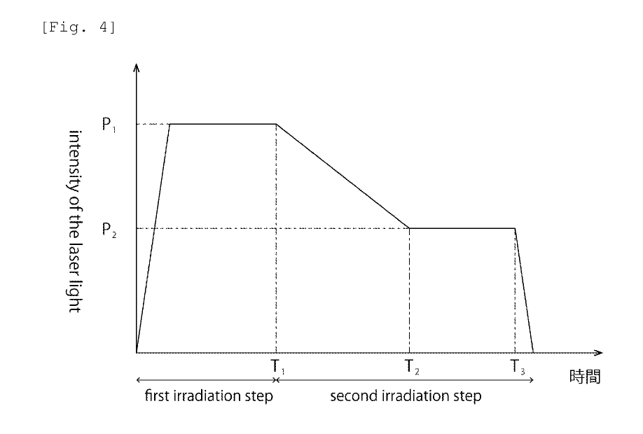

As shown in FIG. 3, in this embodiment, specifically, a levitated block 12 of glass raw material is first heated to melting by irradiating the block 12 of glass raw material with laser light (first irradiation step). In the first irradiation step, the power of the laser light applicator 13 is controlled so that the intensity of the laser light is P₁. The block 12 of glass raw material is irradiated with laser light of intensity P₁ until a time T₁ when the block 12 of glass raw material is fully melted by heat. The time T₁ can be appropriately set according to the intensity P₁ of the laser light, the size of the block 12 of glass raw material, and so on. The time T₁ can be, for example, about 10 seconds to about 30 seconds. The intensity P₁ can be appropriately set according to the type of a source of laser light, the size of the block 12 of glass raw material, and so on.

Next, the power of the laser light applicator 13 is lowered to reduce the intensity of laser light being applied to the molten glass and the irradiation with the laser light is then stopped (second irradiation step). In this embodiment, specifically, the intensity of laser light is reduced to P₂ which is lower than P₁. The intensity P₂ is of such a degree that the temperature of the molten glass does not reach below the softening temperature during a period when the molten glass is irradiated with laser light of intensity P₂. The ratio of the intensity P₂ of laser light just before the irradiation with the laser light is stopped to the intensity P₁ of laser light applied during heating to melting of the block 12 of glass raw material (P₂/P₁) is preferably 0.95 or less, more preferably 0.9 or less, and still more preferably 0.8 or less.

In this embodiment, the intensity of laser light is gradually reduced between the time T₁ and a time T₂. The period (T₂-T₁) between the time T₁ and the time T₂ is preferably, for example, about 3 seconds to about 10 seconds. However, the present invention is not limited to this. For example, the intensity of laser light may be reduced at once from the intensity P₁ to the intensity P₂.

The inventors have found, as a result of intensive studies, that, amazingly, when the intensity of laser light being applied to the molten glass is reduced and the irradiation with the laser light is then stopped, the development of cracks or breakage being produced in a glass material can be reduced, for example, even in the case where the glass material is large. Generally, in order to reduce the development of cracks or breakage in a glass material being produced, it is believed to be important to lower the cooling rate in a temperature range from near the softening temperature to near the strain point, and it is believed that the cooling rate at temperatures higher than the softening temperature has no effect on the development of cracks or breakage. Therefore, this was a very astonishing fact for persons skilled in the art.

The reason why the development of cracks or breakage in a glass material being produced can be reduced by lowering the intensity of laser light being applied to the molten glass and then stopping the irradiation with the laser light is not clear but can be considered as follows. By reducing the intensity of laser light being applied to the molten glass and then stopping the irradiation with the laser light, the maximum temperature difference between a central portion and a peripheral portion of the glass material can be reduced. Therefore, the internal stress arising between the central portion and the peripheral portion of the glass material can be reduced. Hence, cracks or breakage can be considered to become less likely to be developed in the glass material.

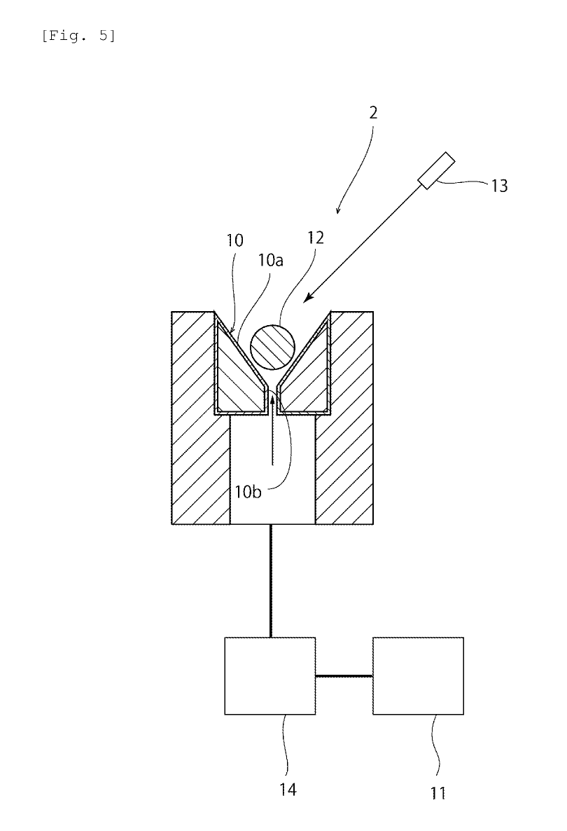

From the viewpoint of effectively reducing the development of cracks or breakage in a glass material being produced, the intensity of laser light is preferably gradually reduced in the second irradiation step. Furthermore, as shown in FIG. 4, it is preferred to gradually reduce the intensity of laser light to P₂ and then put a period during which the intensity of laser light is held at P₂. The period (T₃-T₂) is preferably not less than three seconds and more preferably not less than five seconds. However, if the period (T₃-T₂) is too long, the time taken to produce a glass material becomes long. Therefore, the period (T₃-T₂) is preferably not more than 20 seconds and more preferably not more than 10 seconds.

The ratio (P₂/P₁) is preferably 0.95 or less, more preferably 0.9 or less, and still more preferably 0.8 or less. The intensity of laser light may be gradually reduced until it reaches zero. In other words, P₂ may be zero.

It is preferred to provide a heating mechanism 14 between the gas supply mechanism 11 and the gas jet holes 10b and supply preheated gas into the gas jet holes 10b. By doing so, the cooling rate of the peripheral portion of the glass material can be reduced. Thus, the maximum temperature difference between the central portion and the peripheral portion of the glass material can be further reduced. The temperature of gas supplied into the gas jet holes 10b is preferably not less than 100° C., more preferably not less than 200° C., and still more preferably not less than 400° C. However, if the temperature of gas supplied into the gas jet holes 10b is too high, the temperature of the forming die 10 may become excessively high. If the temperature of the forming die 10 becomes excessively high, the molten glass may be fusion bonded to the forming surface 10a, so that crystals may be formed in the glass material. Therefore, the temperature of gas supplied into the gas jet holes 10b is preferably not more than 1000° C. and more preferably not more than 900° C.

Hereinafter, a description will be given of another example of a preferred embodiment for working of the present invention. In the following description, elements having functions substantially in common with the first embodiment above will be referred to by the common reference signs and further explanation thereof will be omitted.

### Second Embodiment

FIG. 5 is a schematic cross-sectional view of a glass material production device 2 according to a second embodiment.

In the first embodiment, a description has been given of an example where a plurality of gas jet holes 10b open on the forming surface 10a. However, the present invention is not limited to this configuration. For example, as in a glass material production device 2 shown in FIG. 5, a single gas jet hole 10b opening at the center of the forming surface 10a may be provided. Also in this case, like the first embodiment, when the intensity of laser light being applied to the molten glass is reduced and the irradiation with the laser light is then stopped, the development of cracks or breakage in a glass material being produced can be reduced, so that the glass material can be stably produced.

### REFERENCE SIGNS LIST

1, 2: glass material production device
10: forming die
10a: forming surface
10b: gas jet hole
11: gas supply mechanism
12: block of glass raw material
13: laser light applicator
14: heating mechanism

1. A glass material production method for obtaining a glass material by heating a levitated block of glass raw material to melting by irradiation of the block of glass raw material with laser light to thus obtain a molten glass and then cooling the molten glass, the glass material production method comprising:
a first irradiation step of heating the levitated block of glass raw material to melting by irradiating the block of glass raw material with the laser light; and
a second irradiation step of reducing an intensity of the laser light being applied to the molten glass and then stopping the irradiation with the laser light.

2. The glass material production method according to claim 1,
wherein the intensity of the laser light is gradually reduced in the second irradiation step.

3. The glass material production method according to claim 1, wherein a ratio of the intensity P₂ of the laser light just before the irradiation with the laser light is stopped to the intensity P₁ of the laser light applied during heating to melting of the block of glass raw material (P₂/P₁) is 0.95 or less.

4. The glass material production method according to claim 1, wherein
the block of glass raw material is irradiated with the laser light in a state where the block of glass raw material is held levitated above a forming surface of a forming die by jetting gas through a gas jet hole opening on the forming surface, and
the gas is preheated and supplied into the gas jet hole.
